(19) United States
(12) Patent Application Publication
(10) Pub. No.: US 2010/0246969 A1
(43) Pub. Date: Sep. 30, 2010

(54) COMPUTATIONALLY EFFICIENT LOCAL IMAGE DESCRIPTORS

(75) Inventors: Simon A. J. Winder, Seattle, WA (US); Gang Hua, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/410,469

(22) Filed: Mar. 25, 2009

(51) Int. Cl. G06K 9/46

(52) U.S. Cl. 382/195

(57) ABSTRACT

Described is a technology in which an image (or image patch) is processed into a highly discriminative and computationally efficient image descriptor that has a low storage footprint. Feature vectors are generated from an image (or image patch), and further processed via a polar Gaussian pooling approach (a DAISY configuration) into a descriptor. The descriptor is normalized, and processed with a dimension reduction component and a quantization component (based upon dynamic range reduction) into a finalized descriptor, which may be further compressed. The resulting descriptors have significantly reduced error rates and significantly smaller sizes than other image descriptors (such as SIFT-based descriptors).

### BACKGROUND

In certain contemporary computing applications, there is a need to match one image to another. For example, Windows Live™ Photo Gallery has a panorama stitcher that includes a computational stage to determine what parts of multiple images match one another.

One type of image matching technology is based upon the extraction of local image descriptors from images, which can be compared to one another for similarity. In general, the more discriminating, computationally efficient and memory efficient the descriptors are, the more beneficial such image descriptors are for applications and for storage.

The well-known SIFT descriptors consume 128 bytes and have around a 26.1 percent error rate. Any reductions in memory size and/or error rate with respect to such image descriptors are desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an image (or part of the image, such as a rectangular image patch) is processed, e.g., via a pipeline, to generate a local image descriptor that represents the image. Features of the image's pixels are transformed into feature vectors, which are combined into a descriptor. The descriptor is normalized into a descriptor having a number of dimensions. Dimension reduction is performed on the normalized descriptor to generate a local image descriptor having a reduced number of dimensions. The local image descriptor may be further quantized and/or compressed.

In one aspect, transforming the image into the feature vectors comprises computing quantized gradients, rectified gradients and/or using steerable filters. Combining the feature vectors may include spatially accumulating weighted filter vectors using normalized Gaussian summation regions arranged in a plurality of concentric rings. Normalizing the descriptor may be iterative, and may include normalizing the descriptor to a unit vector, clipping the elements of the vector that are above a threshold, and/or re-normalizing to a unit vector after clipping.

Dimension reduction may be based upon principal components analysis to obtain a reduced transformation matrix. Further normalization may take place after performing the dimension reduction.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example pipeline implementation for producing computationally efficient image descriptors.

FIGS. 2A-2D are representations of DAISY Gaussian summation regions for processing feature vectors extracted from an image for conversion to image descriptors.

FIG. 3 is a flow diagram representing example steps taken in an iterative normalization stage to process feature vectors into image descriptors.

FIG. 4 is a block diagram representing aspects of dimension reduction that reduces the dimensions of a descriptor.

FIG. 5 shows an illustrative example of a computing environment into which various aspects of the present invention may be incorporated.

### DETAILED DESCRIPTION

Various aspects of the technology described herein are generally directed towards providing local image descriptors that are highly discriminative, computational efficient, and have a low storage footprint, e.g., 13 bytes per descriptor and 13.2 percent error rate, (compared with 128 bytes and 26.1 percent error rate for SIFT). As can be readily appreciated, this makes practical a number of new scenarios, such as mobile phone database searching for recognition of objects, city scale image-based localization, real-time augmented reality gaming, and so forth.

To this end, described herein is learning such descriptors that are simple to compute, both sparsely and densely, and which in one implementation makes use of a DAISY configuration (a polar Gaussian pooling approach in which circles represent a Gaussian weighting function). Also described are robust normalization, dimension reduction and dynamic range reduction to increase the discriminative power while reducing the storage requirements of the learned descriptors.

While the examples described herein are directed towards image matching, it is understood that these are only examples of a way to use image descriptors, and than other uses of computationally efficient image descriptors will likewise benefit (e.g., face recognition). As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and image descriptor technology in general.

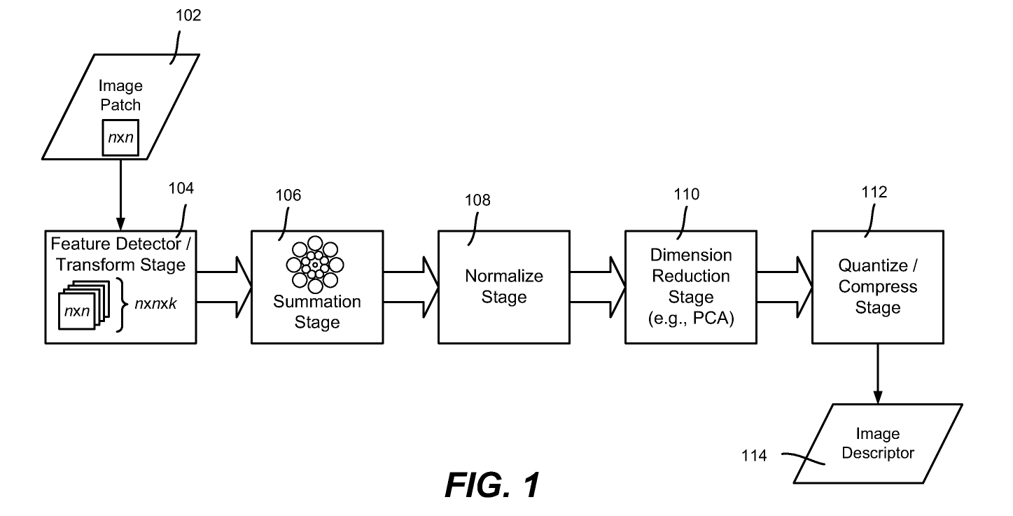

Turning to FIG. 1, there is shown a general block diagram representing various processing stages for computing image descriptors, thereby forming a descriptor pipeline. In general, and as described below, the pipeline processes an image patch 102 to provide a local image descriptor 103, such as for use in matching images. The descriptor pipeline may include a feature detector/transform stage 104, a summation stage 106 (e.g., Gaussian polar), a normalization stage 108, a dimension reduction stage 110 (e.g., for PCA-based dynamic range reduction) and a descriptor quantization/compression stage 112. Various algorithms are feasible for each stage, and those described herein have been found to provide a computationally efficient process with memory efficient descriptors having a low error rate.

As represented in FIG. 1, an input patch 102 (such as an n×n square or n×m rectangular set of pixels within an image) is fed into the feature detector/transform stage 104. Note that the patch may be the entire image, but is typically a smaller portion such as corresponding to a particular point-of-interest as identified by a known algorithm. For example, descriptors can be sampled densely in an image for applications such as stereo reconstruction or face recognition, and/or may be computed from scaled and rotation-normalized patches sampled from a vicinity of interest points for location matching and three-dimensional reconstruction. As used herein as an example, the input comprises a square (n×n) image patch that the pipeline processes to produce the image descriptor 114 as a reduced-dimension vector that distinctively characterizes the region while being robust to common imaging distortions.

In general, the feature detector/transform stage 104 takes the pixels from the image patch 102 and transforms the pixels to produce a vector of k non-linear filter responses at each pixel. In various implementations, rectified or angle quantized gradients and/or steerable filters provide very good features for use in the pipeline. With respect to using gradients to provide the vectors, a Gaussian pre-smoothing stage may be used to set the gradient scale, that is, to smooth the image pixels using a Gaussian kernel of standard deviation 94 ₛ as a preprocessing stage to allow the descriptor to adapt to an appropriate scale relative to the interest point scale.

In one implementation, quantized gradients are used, which in general involves soft histogramming of the gradient angle into k bins. More particularly, this performed by computing gradients at each pixel with the gradient angle bilinearly quantized into k orientation bins (e.g., as in SIFT). More particularly, the gradient vector is evaluated at each sample to recover its magnitude m and orientation θ. The orientation is then quantized to k directions, with a vector of length k constructed such that m is linearly allocated to the two circularly adjacent vector elements i and i+1 representing θᵢ<θ<θᵢ₊₁ according to the proximity to these quantization centers; the other elements are zero. Note that k equals four directions or k equals eight directions are suitable.

In one implementation directed towards rectified gradients, the gradient vector is evaluated at each sample to rectify its x and y components to produce a vector of length four: {|∇x|−∇x; |∇x|+∇x; |∇y|−∇y; |∇y|+∇y|}. This provides a natural sine-weighted quantization of orientation into four directions. This may be extended to eight directions by concatenating an additional length four vector using ∇₄₅ which is the gradient vector rotated through forty five degrees. Selectivity may be narrowed by subtracting the mean on:

$${v}_{i}^{′} = max ( \sum {v}_{i} - \frac{α}{k} {v}_{i} \cdot 0 ) ,$$

which may result in significantly improved error rates; (α≈2:5 was found to be a good value).

In one implementation, k steerable filters (second order steerable filters have been found suitable) were used to produce the vectors, where k represents the number of filter channels. Each pixel is processed through the filters and thus there are n×n×k vectors produced for the n×n patch. More particularly, for every pixel, there are k outputs at different orientations, (e.g., four, with odd and even for each orientation provides eight outputs), resulting in a vector of length k for each pixel. The filters can have odd, even or dual phase, and their responses may be rectified into positive and negative parts which are then carried by different vector elements (as with gradient rectifying) so that the combined vector has only positive elements. For dual phase (quadrature) filters, the vector dimensionality is k=4n, where n is the number of orientation channels. Note that using both phases produces a significantly better error rate than odd or even filters alone.

Once the feature vectors are obtained, they are fed as inputs to the summation stage, which processes each one. In general, the summation stage spatially accumulates weighted filter vectors to give N linearly summed vectors of length k which are concatenated to form a descriptor of kN dimensions. The summation stage 106 may use any of various methods to sum the feature information over space, however, in one implementation, concentric Gaussian spots (that is, a DAISY) configuration gives good results and results in descriptors hat are tolerant to rotation and scaling with high computation efficiency.

More particularly, for this stage 106, normalized Gaussian summation regions may be used, arranged in a series of concentric rings (sometimes referred to as S4 or the DAISY descriptor). In general, each feature vector fⱼ(x,y) is multiplied by a Gaussian function gᵢ(x,y) (where g is based upon a scale factor and the size of each circle, σ, which represents the standard deviation) and summed to provide raw feature vectors N(i,j):

$$N ( i , j ) = {\sum }_{x , y} {f}_{j} ( x , y ) {g}_{i} ( x , y )$$

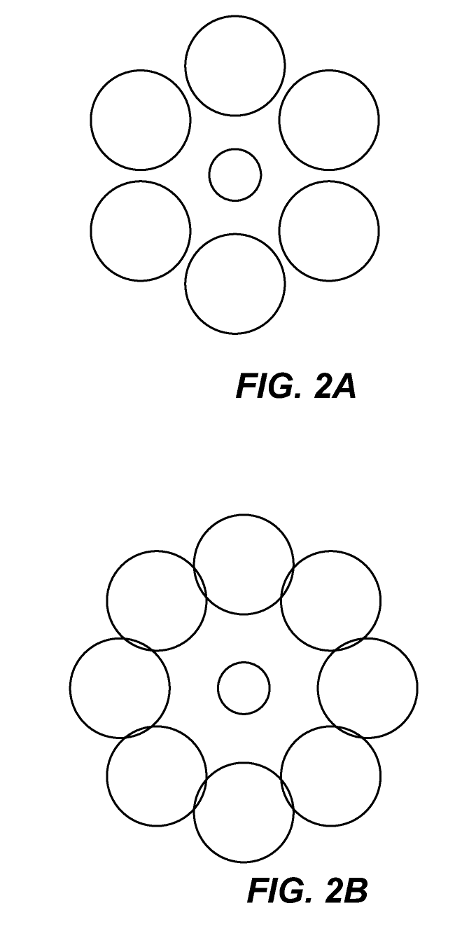

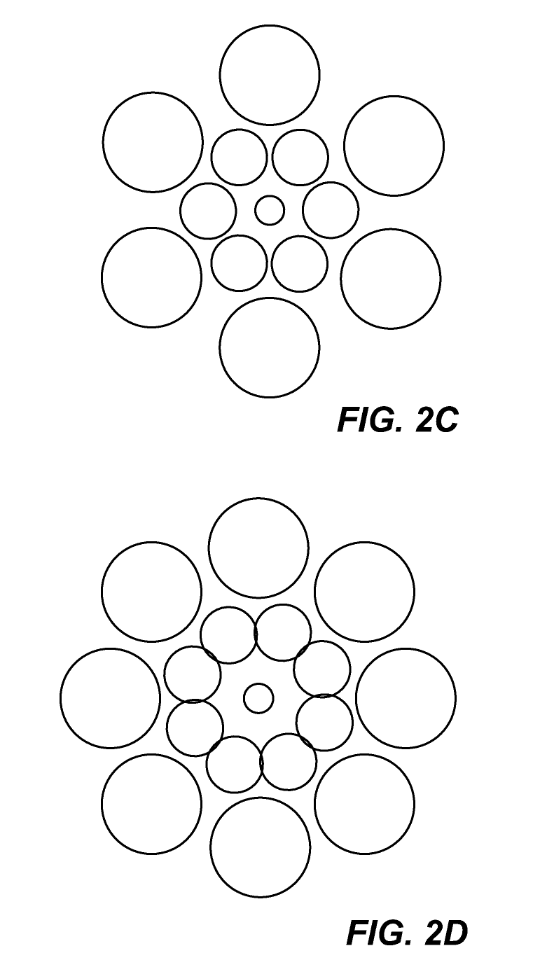

Typical DAISY configurations are shown in FIGS. 2A-2D, (1 Ring, 6 Segments; 1 Ring, 8 Segments; 2 Rings, 6 Segments; and 2 Rings, 8 Segments, respectively). Note that acceptable results were obtained by offsetting concentric rings by 180/n degrees, where n is the number of segments. Further, configurations with two DAISY rings tend to result in significantly better error rates than single ring configurations. The size constants of the Gaussians and the radii of the rings are optimized parameters. The total number of dimensions at this stage D=k (1+rings×segments).

Turning to the next stage 108, normalization may be performed in order to make descriptors less sensitive to lighting changes. Normalization may further include range clipping to make the descriptors robust to occlusions and shadow effects. Note that the vector arrays may be concatenated together into one array, e.g., v_{i,j} becomes Nₖ.

In this stage 108, the complete descriptor is thus normalized to provide invariance to lighting changes, which may be accomplished via various techniques. One possible technique is to use simple unit-length normalization, while another option is to use SIFT-style threshold normalization.

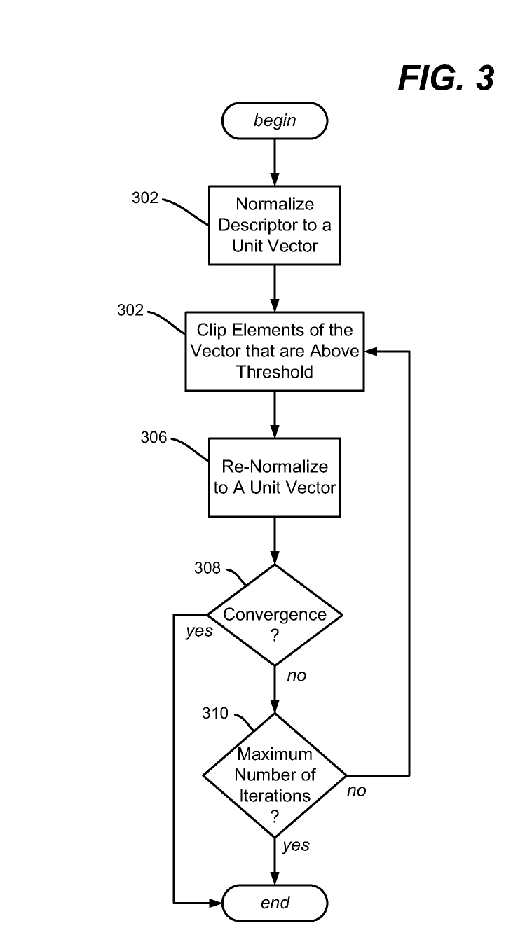

Described herein is a form of iterative thresholding (somewhat similar to SIFT) as generally represented in the steps of FIG. 3. Step 302 normalizes to a unit vector, e.g., by dividing by its vector length. Step 304 clips the elements of the vector that are above a threshold K by computing N′ₖ=min(Nₖ, κ). Step 306 re-normalizes to a unit vector. Iteration is performed by returning to step 304 until convergence (step 308) or a maximum number of iterations has been reached (step 310). This procedure has the effect of reducing the dynamic range of the descriptor and creating a robust function for matching. The threshold value κ may be learned, and has been found to provide good results with a value of 1.6/\sqrt{D}, where D is the total number of dimensions as described above.

Turning to the dimension reduction stage 110, descriptor dimensions may be quantized with little drop in matching performance. Note that this stage is optional, but provides significant benefits. In one implementation, principal components analysis (PCA) dimension reduction is used, which not only reduces the number of dimensions thereby leading to lower storage requirements, but further improves the reliability of the descriptors by throwing away noise dimensions that often contribute considerably to the rate of error. Note that PCA is applied to image filter responses without class labels, which is effective when the high-dimensional representation is already discriminative.

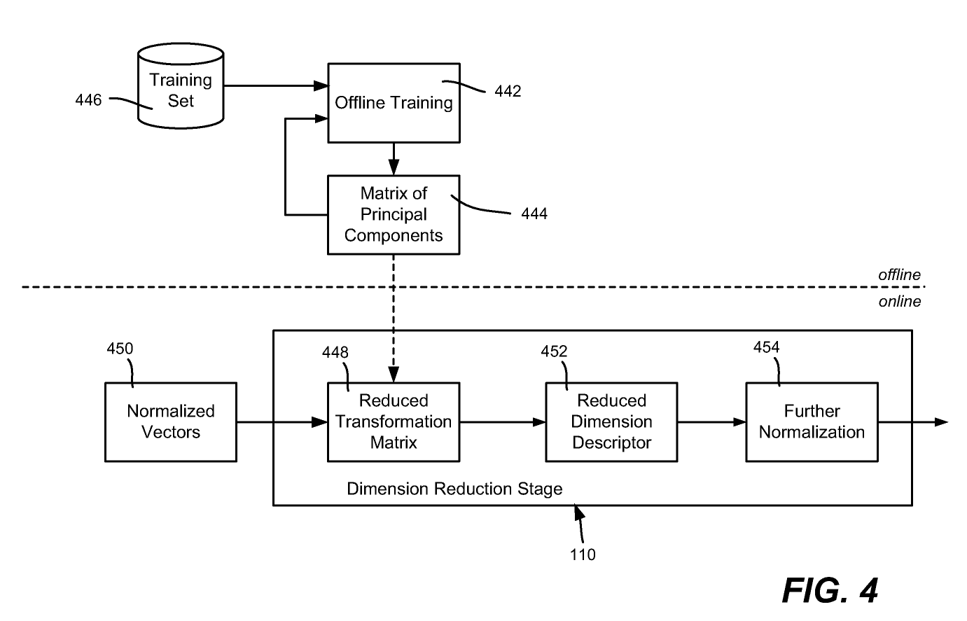

To learn PCA projections, the parameters of the descriptor are optimized by an offline training process 442 (FIG. 4), with the matrix of principal components 444 computed based on the descriptors computed on a training set 446 (e.g., offline). The dimensionality for reduction may be found by computing the error rate on random subsets of the training data 446, while progressively increasing the dimensionality by adding PCA bases until a minimum error is found.

This gives a final reduced transformation matrix 448 for the descriptor pipeline, that is, the normalized vectors 450 are processed by the matrix 448 into reduced dimension vectors 452. Additionally, the length of descriptor vectors may be normalized following the dimension reduction stage (block 454).

In the quantization/compression stage 112, dynamic range quantization may be performed to reduce memory requirements when large databases of descriptors are stored. Descriptor elements (either signed when PCA reduction is used or unsigned when it is not) are quantized into L levels; (note that in one implementation, PCA-reduced dimensions are quantized to the same number of levels despite their differences in variance). In essence, this corresponds to a histogram with a value for each level.

For example with signed descriptor elements Pᵢ and L an odd number of levels, quantized elements qᵢ=└βLPᵢ+0.5┘, where qᵢ ∈ {−(L−1)/2, . . . , (L−1)/2} and β is a single common scalar which may be optimized to give the best error rate on the training data. For even numbers of levels, qᵢ=└βLvᵢ┘ with qᵢ ∈ {−L/2, . . . , L/2−1}. Sixteen levels have been found to be sufficient for most applications.

Further, the quantized output may be compressed. Huffman coding or arithmetic coding of the vector element are two possible ways to perform the compression.

As can be seen, there are provided image descriptors having a low error rate, low computation burden and low storage footprint. Note that parameters for the descriptors may be optimized for matching around interest points, but in general perform well in various related applications. For example, some scenarios are of interest when selecting from the range of descriptors that are available include real-time, e.g., for mobile devices, highly-discriminative, e.g., for object class recognition, and large databases, e.g., for image search or geolocation from images.

For example, in a real time mobile device application, low computational burden and/or small descriptors are likely more beneficial. In such a scenario, the rectified gradient alternative with four vectors and one or two rings provide low computation cost and have low dimensionality. They can also be quantized to 2-3 bits per dimension without PCA.

As another example, for applications that require good discrimination, the descriptors with the lowest error rate are desirable. This may be achieved through use of second order steerable filters at two spatial scales, with PCA applied to remove nuisance dimensions.

As yet another example, large data-base applications benefit from a descriptor with very low storage requirements and relatively low computational burden. Steerable filters (e.g., second order, four dimensions, two rings, eight segments), or the rectified gradient technique (e.g., four dimensions, one ring, eight segments) with PCA produce good candidates as they consume relatively few bytes of storage.

Although the descriptors may be computed on rotated patches, computational benefit results from using approximate discrete rotations by permuting the feature detector/transform output and rotating the DAISY point sampling pattern, or by permuting the descriptor after normalization in the case where the number of feature detector/transform orientations is suitably matched with the number of DAISY segments. Descriptors with this rotation property may be provided by varying the parameters and feature detector/transform techniques.

### Exemplary Operating Environment

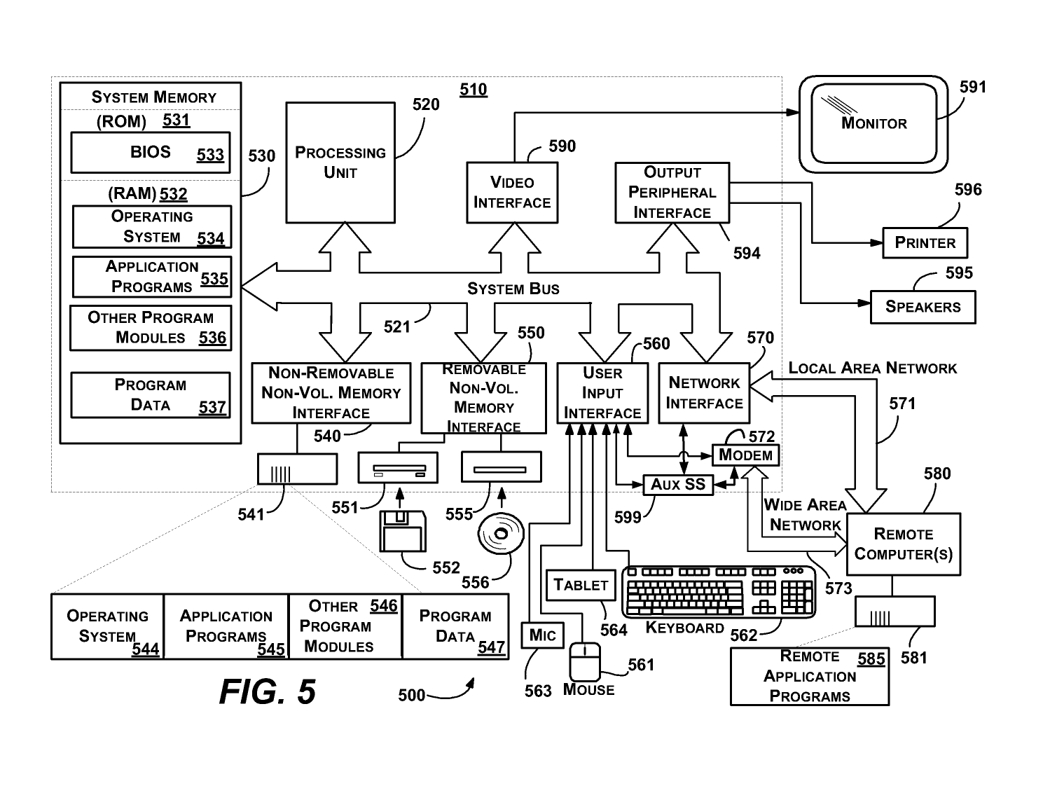

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, transforming an image into feature vectors based upon features within the image, combining the feature vectors into a descriptor, normalizing the descriptor into a normalized descriptor, and performing dimension reduction on the normalized descriptor to generate a local image descriptor.

2. The method of claim 1 further comprising, selecting the image as a rectangular patch of a larger image.

3. The method of claim 1 further comprising, quantizing the local image descriptor.

4. The method of claim 1 further comprising, compressing the local image descriptor.

5. The method of claim 1 further comprising, smoothing values of pixels of the image.

6. The method of claim 1 wherein transforming the image into the feature vectors comprises computing gradients at each pixel corresponding to a gradient angle and quantizing the gradient angle.

7. The method of claim 1 wherein transforming the image into the feature vectors comprises determining a gradient vector and rectifying the gradient vector.

8. The method of claim 1 wherein transforming the image into the feature vectors comprises processing each pixel using a plurality of steerable filters.

9. The method of claim 1 wherein combining the feature vectors into a descriptor comprises spatially accumulating weighted filter vectors using normalized Gaussian summation regions arranged in a plurality of concentric rings.

10. The method of claim 1 wherein normalizing the descriptor comprises normalizing the descriptor to a unit vector, and clipping elements of the vector that are above a threshold.

11. The method of claim 1 wherein normalizing the descriptor comprises (a) normalizing the descriptor to a unit vector, (b) clipping the elements of the vector that are above a threshold, (c) re-normalizing to a unit vector, and (d) returning to step (b) until convergence or a certain number of iterations has been reached.

12. The method of claim 1 wherein performing dimension reduction comprises using principal components analysis to obtain a reduced transformation matrix.

13. The method of claim 1 further comprising, performing further normalization after performing the dimension reduction.

14. In a computing environment, a system comprising, a feature detector that transforms pixels into feature vectors, a summation component that spatially accumulates the feature vectors into a descriptor having a number of dimensions, a dimension reduction component that reduces the number of dimensions of the descriptor, and a quantization component that reduces the reduced-dimensions descriptor into a local image descriptor.

15. The system of claim 14 further comprising first normalization means for normalizing the descriptor before the summation component, and second normalization means for normalizing the reduced-dimensions descriptor before the quantization component.

16. The system of claim 14 wherein the feature detector comprises a quantized gradient mechanism, a rectified gradient mechanism, or a steerable filters mechanism, or any combination of a quantized gradient mechanism, a rectified gradient mechanism, or a steerable filters mechanism.

17. The system of claim 14 wherein the dimension reduction component includes a reduced transformation matrix.

18. One or more computer-readable media having computer-executable instructions, which when executed perform steps, comprising generating a local image descriptor from an image, including producing a feature vector for each of a set of sample points of the image, spatially accumulating weighted versions of the feature vectors that are combined to form an image descriptor by summing the feature vectors associated with sample points found within a local pooling region relative to a pooling point which is part of a pattern of pooling points located in the image, normalizing the descriptor, and reducing a number of dimensions of the descriptor into the local image descriptor.

19. The one or more computer-readable media of claim 18 having further computer-executable instructions comprising, quantizing the local image descriptor into a quantized local image descriptor.

20. The one or more computer-readable media of claim 18 having further computer-executable instructions comprising using data corresponding to the local image descriptor to determine similarity of the image to another image.
